(19) United States
(12) Patent Application Publication
(10) Pub. No.: US 2025/0308278 A1
(43) Pub. Date: Oct. 2, 2025

(54) LIMITED FIELD INFORMATION EXTRACTORS FOR DOCUMENTS

(71) Applicant: Intuit, Inc., Mountain View, CA (US)

(72) Inventors: Peter Caton ANTHONY, Menlo Park, CA (US); Mathew BERNSTEIN, Philadelphia, PA (US); Peter Lee FRICK, San Francisco, CA (US); Sparsh GUPTA, Secaucus, NJ (US); Harshada Baswaraj JIVANE, San Jose, CA (US)

(21) Appl. No.: 18/620,046

(22) Filed: Mar. 28, 2024

(51) Int. Cl. G06V 30/416; G06F 40/174; G06Q 40/12; G06V 30/19; G06V 30/414

(52) U.S. Cl. CPC G06V 30/416; G06F 40/174; G06Q 40/123; G06V 30/19147; G06V 30/414

(57) ABSTRACT

Certain aspects of the disclosure provide techniques for automated information extraction. A method generally includes performing optical character recognition (OCR) on a document to generate OCR data; iteratively, for one or more field keys of the document: generating a prompt comprising the OCR data and a field key of the one or more field keys; prompting a large language model (LLM) with the prompt to extract a field value corresponding to the field key; and receiving, from the LLM, an extracted field value from the document; and providing one or more extracted field values from the document to an application for further processing.

### BACKGROUND

### Field

Aspects of the present disclosure relate to automated information extraction.

### Description of Related Art

Automated information extraction is the process of extracting information from electronic data without manual intervention. For example, automated information extraction may involve using automated methods and/or tools to scan and extract information from various sources, and, in some cases, convert the extracted information into a usable and meaningful format for further analysis, reporting, and/or storage. The various sources from which information is extracted may include text, documents, images, forms, tables, spreadsheets, receipts, invoices, and others. The extracted information may be used in various applications and/or analytics downstream in many different industries, including engineering, healthcare, education, government, mathematics, human resources, and finance, to name a few.

For example, in the field of human resources and recruitment, automated information extraction may be used to extract relevant information from job applicants' resumes or CVs. The extracted information may be stored and analyzed by an applicant tracking system used to track candidates throughout recruiting and/or hiring processes. As another example, in the finance industry, automated information extraction may be used to extract relevant information from tax forms, invoices, and/or receipts (e.g., in some cases provided as images by a taxpayer) to perform tax calculations and/or prepare a taxpayer's tax return.

### SUMMARY

One aspect provides a method of extracting information, comprising: performing optical character recognition (OCR) on a document to generate OCR data for use in an application; iteratively, for one or more field keys of the document: generating a prompt comprising the OCR data and a field key of the one or more field keys; prompting a limited field extractor (e.g., a large language model (LLM)) with the prompt to extract a field value corresponding to the field key; and receiving, from the limited field extractor, an extracted field value from the document; and providing one or more extracted field values from the document to the application for further processing.

Another aspect provides a method of training a limited field extractor (e.g., a LLM) to perform information extraction, comprising: for each respective document type of one or more document types: for each respective field key of one or more field keys: fine tuning the limited field extractor to extract a field value corresponding to the respective field key in the respective document type using first training prompts comprising, at least: OCR data from the respective document type; and the respective field key.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system implementing a limited field information extractor.

FIGS. 2A-2C depict an example workflow used to extract information for fields of a document via limited field extraction.

FIG. 3 depicts example use of extracted information by a downstream application.

FIG. 4 depicts an example comparison of accuracy achieved when performing multi-field and limited field information extraction.

FIG. 5 depicts an example method of extracting information for use in an application.

FIG. 6 depicts another example method of extracting information for use in an application.

FIG. 7 depicts an example method of training a limited field extractor to perform automated information extraction.

FIG. 8 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Automated information extraction workflows are intended to increase productivity, accuracy, and accessibility, among other things, for a myriad of applications. However, errors in automated information extraction may not only directly cause downstream processing problems (e.g., from downstream processes ingesting incorrectly extracted information), but also have a disproportionality negative effect on users. For example, a user is likely to remember the one field that was extracted incorrectly, owing to the problems it caused, rather than the nine others that were extracted correctly. In short, the tendency is to expect perfection, and customers are often lost to objectively well-performing functions (e.g., the aforementioned 90% effective extractor).

One example of a common information extraction problem is extracting tax information from tax forms, such as a W-2, 1099-DIV, etc. Information extraction from such forms normally entails utilizing models to extract key-value pairs for a set of fields (e.g., where each field acts as a placeholder for information) in each document. For example, a field in a W-2 form is “Wages, tips, other compensation” and that field can be the key of a key-value pair, where the value may be a numeric value such as “$100,000.00.” In some cases, optical character recognition (OCR) is a precursor step to processing with an extraction model.

Existing information extraction models are generally designed to maximize both field/key coverage (e.g., the fraction of populated fields for which a value is extracted) and accuracy (e.g., the fraction of extracted fields for which the value is correct). However, some fields are more difficult to extract than others, for example, fields that are used less often and thus generate less training data. Further, some fields have greater importance to the downstream task than others. Experimentation shows that models trained to perform comprehensive extraction (e.g., of all fields in a particular document type) often learn a subset of fields to expect in a given document type (e.g., the most commonly used ones), and consequently perform poorly when extracting information from less commonly used fields—a technical problem in the field of automated information extraction. Returning to the W-2 example, fields like boxes 12a-12d, which are less regularly used, tend to have low extraction accuracy for models trained to comprehensively extract information from a W-2.

Embodiments described herein overcome the aforementioned technical problems and improve upon the state of the art by training limited field extraction models (also referred to herein as “limited field extractors”) to extract information for less than all fields included in a document at a time. For example, the limited field extractor may be a large language model (LLM) trained to extract a single field value at a time (e.g., from a document) and in such cases may be referred to as a single field extractor. Advantageously, an LLM trained as a single field extractor may be flexibly prompted to extract specific fields, one-by-one, in any particular order. As described further herein, an LLM trained to extract less than all fields at a time (e.g., per provided prompt) among a set of fields in a document (e.g., perform limited field extraction) comprehensively outperforms the same type of LLM trained to extract all fields in the set of fields (e.g., perform comprehensive field extraction) at a time. Thus, the limited field extractor LLM maintains the same field coverage as the comprehensive (or “full”) field extractor LLM, but improves the extraction performance across the fields.

As used herein, “at a time” refers to a time period for performing a single extraction (e.g., of one or more field values) using a single prompt, which is a specific instruction and/or request, usually posed in natural language, to perform a useful function, such as information extraction. For example, “at a time” may refer to a period of time for (1) prompting the limited field extractor with a single prompt to perform extraction and (2) receiving an output (e.g., of one or more field values) in response to the prompt. Thus, “a first time” may refer to a first time period for performing a first extraction, “a second time” may refer to a second time period for performing a second extraction, and so forth.

In certain embodiments, the limited field extractor may be an LLM trained to extract information for more than one field included in a document at a time, but for less than all fields included in the document. For example, the limited field extractor may be trained to extract information for a group (e.g., a “subset”) of fields in a document, where a “group of fields” may refer to two or more fields. Different groups of fields (also referred to herein as “groups of field keys”) considered for extraction are described in detail below. Advantageously, an LLM trained to perform limited field extraction for a group of fields, including less than all fields in a document, may provide more accurate extraction than the same type of LLM trained to extract all fields in the document at once. Further, in some cases, extracting more than one field at a time may increase extraction speed where information for multiple fields needs to be extracted.

Use of an LLM as an extractor model has further technical benefits. LLMs are trained to respond to prompts, which are specific instructions and/or requests, usually posed in natural language, to perform a useful function, such as information extraction. Beneficially, the prompt for an LLM-based limited field extractor may include additional information, such as an indication of the type of document (e.g., W-2), an expected format (e.g., pattern) of the extracted information, an expected location of a field, an example of a correct data element extraction, etc. In some embodiments, the additional information includes the OCR text associated with a document from which one or more fields are to be extracted by the extractor model. Including additional prompt information (e.g., beyond just the identification of the field to be extracted) further improves accuracy of limited field extractors and thus represents a further technical improvement in the field.

Techniques for training and fine tuning limited field extractors (e.g., LLMs) are also described herein. In some cases, a limited field extractor may be fine-tuned to extract one or more field values at a time from a document using curated training prompts in order to improve extraction accuracy. For example, training prompts used to train a limited field extractor may alter the order of the one or more fields to be extracted, e.g., through a randomization process. Training a limited field extractor to extract information for a randomized list of prompts helps to ensure that the limited field extractor is capable of selectively identifying each requested field in the OCR data associated with the document, instead of learning to extract information for a same sequence of requested fields.

As another example, training prompts used to train a limited field extractor may include prompts requesting the extraction of fields not present in a particular document and/or not generally present for a particular document type. For example, training prompts may include prompts requesting the extraction of information for a field “MeaningOfLife” for a W-2 document type, which is not a real field typically found within an IRS W-2 form. Alternatively, training prompts may include prompts requesting the extraction of information for a field “Allocated TipsAmt” for a particular document where the field does not exist, although in other documents of the same type the field may exist. Training a limited field extractor to identify non-existent requested fields in OCR data generated for the particular document and/or document type further beneficially helps to discourage hallucination of the limited field extractor when prompted to extract arbitrary fields not present in the OCR data.

As yet another example, training prompts used to train the limited field extractor may include non-extraction type prompts, such as prompts requesting the limited field extractor to answer non-extraction type questions, such as Boolean questions (e.g., asking the single field extractor to identify whether or not a requested field or field value is present in the OCR data generated for a document). Training a limited field extractor to answer non-extraction type prompts helps to improve the robustness of the limited field extractor when instructed, for example, to extract field information in poor OCR data (e.g., inconsistent, incomplete, and/or improperly formatted OCR data). In particular, OCR data generated from a low quality image (e.g., out of focus, poorly lit, rotated, pixelated, etc.) of a document may result in poor OCR data. Further, training a limited field extractor to answer non-extraction type prompts helps to improve the robustness of the limited field extractor when instructed, for example, to extract field information in OCR data associated with complex and/or confusing documents. For example, OCR generally assumes that text in a document (e.g., for which OCR data is to be generated) is organized/laid out from left to right, and from top to bottom. Complex and/or confusing documents, which OCR data is generated from, may instead have text organized in boxes, text organized in tables, include line-items, etc.

These specific examples, and others described herein, have the beneficial technical effect of improving the accuracy of LLM-based extraction models, such as limited field extractors.

Accordingly, the limited field extractors described herein provide significant technical advantages over conventional information extraction models, such as improved extraction accuracy. This improved accuracy beneficially improves the reliability and meaningfulness of information extracted by a limited field extractor and thereby improves downstream processes that utilize the extracted information.

### Example System Implementing a Limited Field Information Extractor

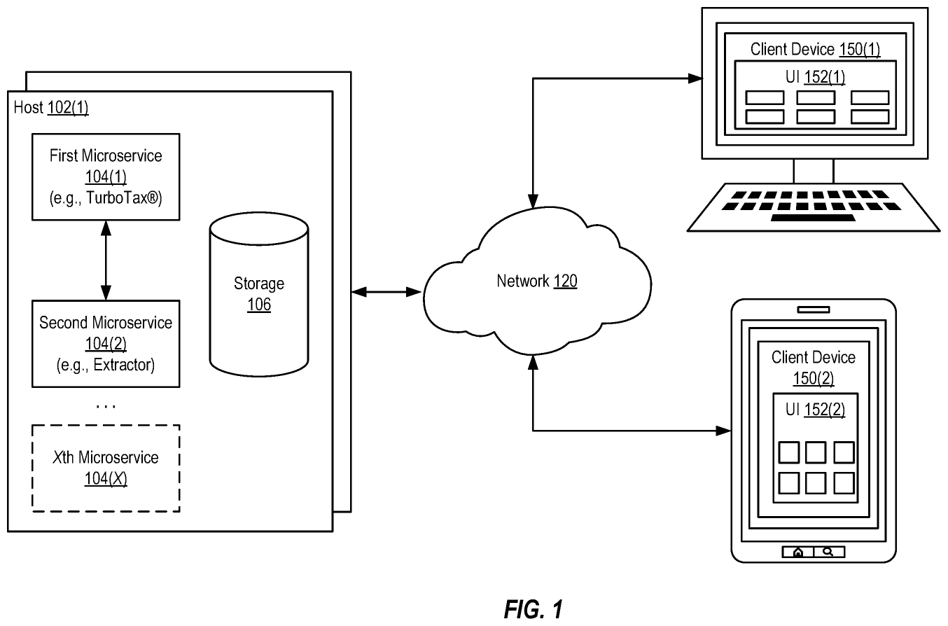

FIG. 1 depicts an example system 100 having a limited field information extractor implemented as a software-defined service (e.g., in some cases, a cloud-native software-defined service), also referred to herein as “a microservice 104.” Microservices 104 are loosely coupled and independently deployable services (or software), which may make up an application. Thus, microservices 104 may enable segmented, granular level functionalities within a larger system infrastructure. It should be understood that the components of system 100 depicted in FIG. 1 and described herein are merely examples and systems with additional, alternative, and/or a fewer number of components may be considered within the scope of this disclosure. For example, a limited field extractor may be implemented as something other than a microservice.

As shown in FIG. 1, system 100 comprises client devices 150(1)-(2) (collectively referred to herein as “client devices 150”) and host(s) 102 interconnected through a network 120. Network 120 may be, for example, a direct link, a local area network (LAN), a wide area network (WAN), such as the Internet, another type of network, or a combination of one or more of these networks.

Host(s) 102 may be geographically co-located servers on the same rack or on different racks in any arbitrary location in a data center. Host(s) 102 may be constructed on a server grade hardware platform and include components of a computing device such as, one or more processors (central processing units (CPUs)), one or more memories (random access memory (RAM)), one or more network interfaces (e.g., physical network interfaces (PNICs) 120), storage 106, and other components (e.g., only storage 106 is shown in FIG. 1).

A first host 102 (1) in system 100 may host a plurality of microservices 104(1)-(X) (collectively referred to herein as “microservices 104”), where X is an integer greater than one. The microservices 104 may be deployed using virtual machines (VMs) and/or container(s) running on first host 102(1) (e.g., where first host 102(1) is running a hypervisor (not shown) used to abstract processor, memory, storage, and networking resources of first host 102(1)'s hardware platform).

Client device 150(1) and client device 150(2) may each include a user interface 152(1), 152(2), respectively, which may be used to communicate with, at least, first microservice 104(1) and second microservice 104(2) using the network 120. For example, communication between client devices 150 and microservice 104 may be facilitated by one or more application programming interfaces (APIs). Examples of client devices 150 may include a smartphone, a personal computer, a tablet, a laptop computer, and or other devices.

As shown in FIG. 1, the microservices 104 may include, at least, a first microservice 104(1) and a second microservice 104(2). In some embodiments, the first microservice 104(1) implements an information service, which is any network 120 accessible service that maintains financial data, medical data, personal identification data, and or other data types. For example, the information service may include TurboTax® and its variants made commercially available by Intuit® of Mountain View, California.

In some embodiments, the second microservice 104(2) implements an information extraction service. As described herein, the information extraction service (or extractor) is a service used to perform automated information extraction from one or more documents stored and/or made available by the information service. In some embodiments, the extraction service implemented by second microservice 104(2) is configured to extract information for a limited set of fields at a time of one or more documents (e.g., a subset of a total set of fields that can be extracted). In some cases, the limited number of fields may be set as a percentage of total fields to be extracted, such as 5%, 10%, 15%, 20%, and so on. In one embodiment, referred to as a single-field extractor, extraction is performed field-by-field (e.g., a single field at a time).

Though FIG. 1 depicts each of first host 102(1), storage 106, client device 150(1), and client device 150(2) as single devices for ease of illustration, first host 102(1), storage 106, client device 150(1), and/or client device 150(2) may be embodied in different forms for different implementations. Further, though FIG. 1 depicts only two hosts 102 and two client devices 150, other embodiments may include more or less hosts 102 and/or client devices 150, and client devices 150 may use any combination of microservices 104 on any host 102 where microservices 104 are deployed.

### Example Workflow for Automated Information Extraction

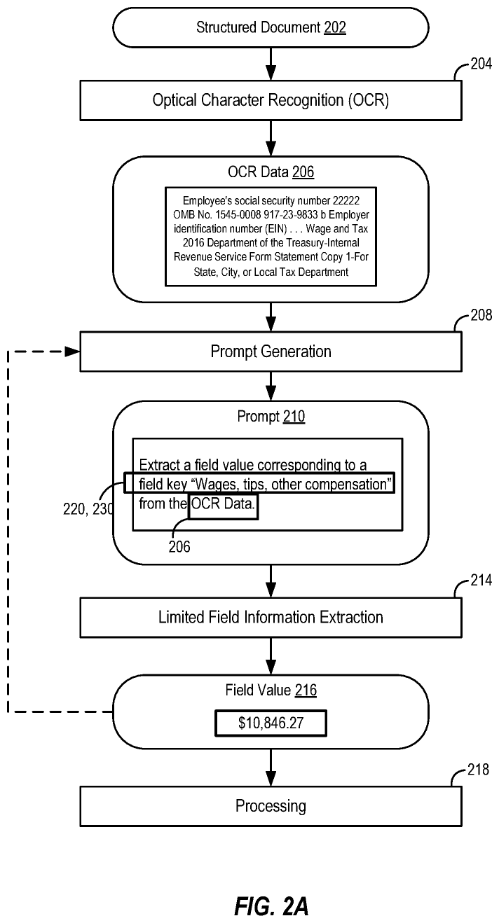

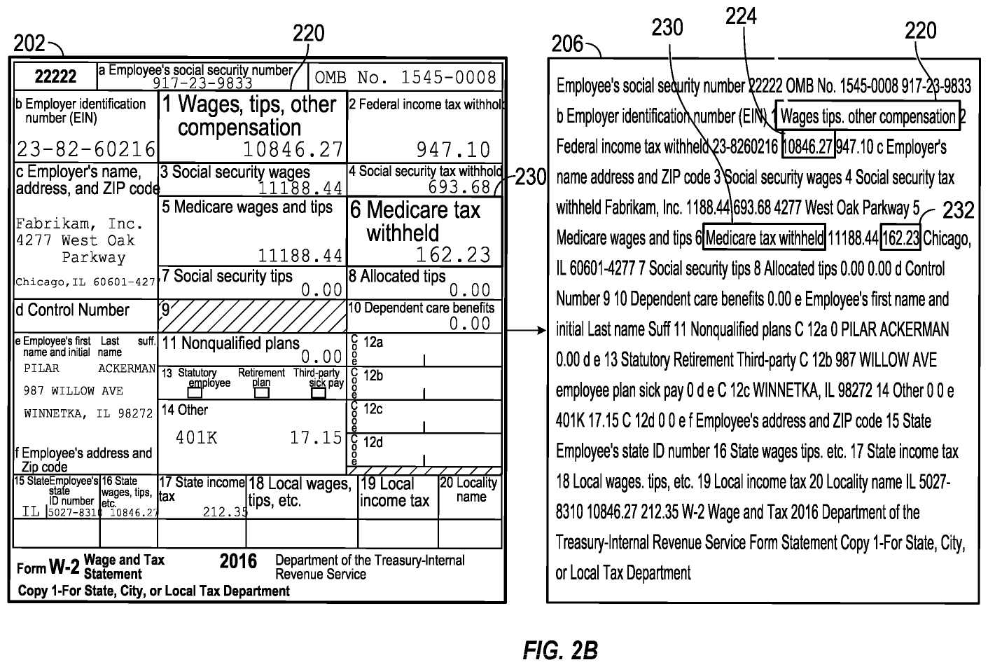

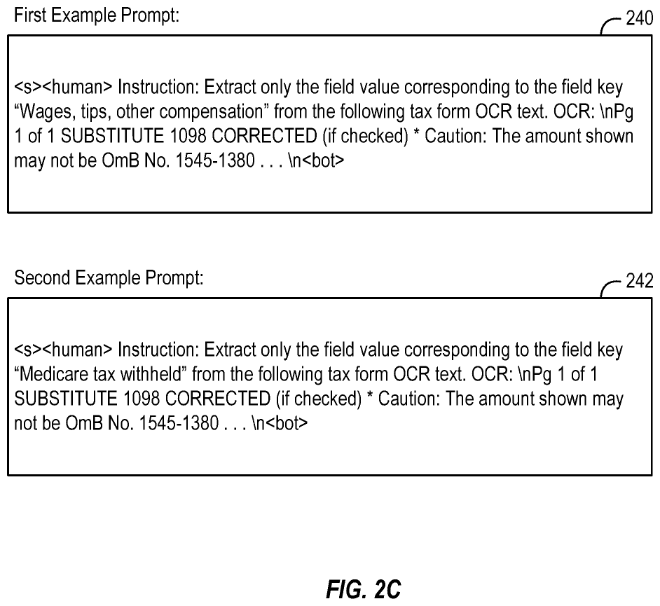

FIGS. 2A-2C depict an example workflow 200 used to extract information for field(s) of a document via limited field extraction. As shown in FIG. 2A, workflow 200 includes steps for (1) OCR 204, (2) prompt generation 208, (3) limited field information extraction 214, and (4) processing 218.

Workflow 200 may be used to extract information for one or more fields of a document 202, but less than all fields of document 202. In certain embodiments, document 202 may be an unstructured document, or a free-form document that does not have a set structure, format, and/or a pre-defined number and/or type of fields. In certain embodiments, document 202 may be a structured document, or a document where the layout, type of fields, and/or number of fields included in the document is consistent (e.g., forms, bills, payment slips, etc.). For example, a structured document may use a pre-defined and expected format with a pre-defined set of fields. In this example, document 202 may be an example IRS Form W-2 including information for an employee, Pillar Ackerman, as shown in FIG. 2B. Document 202 may include pre-defined fields, also referred to herein as “field keys,” such as a “wages, tips, and other compensation” field key 220 and a “Medicare tax withheld” field key 230,” among others. Fields in document 202 may include information, also referred to as “field values,” entered for each respective field key. For example, a field value “10846.27” is entered for “wages, tips, and other compensation” field key 220. Further, a field value “162.23” is entered for “Medicare tax withheld” field key 230.

In certain embodiments, document 202 represents a hard copy or a soft copy (e.g., without recognized text) of a document. Thus, to begin the extraction process illustrated by workflow 200, in certain embodiments, document 202 is scanned to generate a digital version of document 202 that may be processed by workflow 200. In certain embodiments, a photograph of document 202 may be taken and uploaded for processing via workflow 200. In some cases, the scan or photo is captured by a user's mobile device either indirectly (e.g., via a scanning or camera application), or within a native application running on the mobile device for which the extracted information is meant to be used. Further, other suitable methods for generating a digital copy of document 202 may be performed. Although workflow 200 is described with respect to the extraction of field value(s) for field key(s) in IRS Form W-2, steps in workflow 200 may be similarly applied to extract field value(s) for field key(s) in other documents (e.g., via limited field extraction).

OCR 204 includes performing OCR on document 202 to generate OCR data 206 for use in an application. For example, OCR 204 may include processing document 202 by locating and recognizing tokens (e.g., where a token is an individual character, word, sub-word, phrase, or even larger linguistic unit in text) and/or other characters, such as letters, numbers, and/or symbols. OCR 204 may then further include converting the recognized tokens and/or characters to a machine-readable text format (e.g., OCR data 206) that may be understood, for example, by an LLM. OCR data 206 may include raw text from document 202 and/or one or more field key-field value pairs identified during OCR 204. Further, in certain embodiments, OCR data 206 may include geometric information associated with document 202. The geometric information may include information about the positions of different tokens and/or other characters in OCR data 206.

Example OCR data 206 generated for document 202 is depicted in FIG. 2B. As shown, OCR data 206 includes the raw text from document 202. Field keys and field values included in document 202 are included as tokens in a plurality of rows in OCR data 206. Although not shown, geometric information included in OCR data 206 may include information about a first position of language “Wages, tips, other compensation” 202 and a second position of language “10846.27” 224 in OCR data 206. As described herein, this position information may be used by a single field extractor (e.g., implemented as an LLM) when performing single field information extraction (e.g., extracting field value(s), one at a time) for field key(s) in document 202.

Prompt generation 208 includes generating a prompt 210 used to instruct a limited field extractor (e.g., an LLM) to extract, for example, a single field value associated with document 202 at a time. Prompt 210 may include OCR data 206 generated for document 202 during OCR 204. Further, prompt 210 may include a single field key of the field keys associated with document 202. Prompt 210 may request that the limited field extractor extract a field value from OCR data 206, generated for document 202, for a single field key identified in prompt 210 at a time.

For example, FIG. 2C depicts example prompts that may be generated during prompt generation 208 to extract a field value associated with a single field key of example document 202 (e.g., IRS Form W-2) illustrated in FIG. 2B.

First example prompt 240 recites an instruction to:

“Extract only the field value corresponding to the field key ‘Wages,
tips, other compensation’ from the following tax form OCR text.
OCR: \nPg 1 of 1 SUBSTITUTE 1098 CORRECTED (if checked)
* Caution: The amount shown may not be OmB No. 1545-1380 . . .
\n<bot>.”

The OCR text referenced in first example prompt 240 may refer to OCR data 206 generated for document 202. First example prompt 240 may be used to extract a field value for “wages, tips, other compensation” field key 220 (e.g., single field key) associated with document 202. The instruction in first example prompt 240 may be one example of the additional prompt information described above, which has the beneficial technical effect of improving the accuracy of extraction.

Second example prompt 242 recites an instruction to:

“Extract only the field value corresponding to the field key
“Medicare tax withheld” from the following tax form OCR text.
OCR: \nPg 1 of 1 SUBSTITUTE 1098 CORRECTED (if checked)
* Caution: The amount shown may not be OmB No. 1545-1380 . . .
\n<bot>.”

The OCR text referenced in second example prompt 242 may refer to OCR data 206 generated for document 202. Second example prompt 242 may be used to extract a field value for “Medicare tax withheld” field key 230 associated with document 202. The instruction in first example prompt 240 may be another example instruction fed to the limited field extractor to prompt information extraction.

Although the example illustrated in FIG. 2A describes generating, during prompt generation 208, a prompt 210 for the extraction of a single field value associated with a document, in certain other embodiments, prompt generation 208 may include generating a prompt used to instruct a limited field extractor to extract field values for a group of field keys. For example, the prompt may include multiple field keys belonging to a group of field keys associated with a document. As described in detail below, the group of field keys may include field keys associated with a document based on a maximum number of field keys per group, a minimum number of field keys per group, a requested number of field keys per group, semantic similarities and/or differences between the field keys associated with the document, and/or the like.

In certain embodiments, prompt 210, generated during prompt generation 208, includes additional information beyond (1) OCR data 206 and (2) an indication of a field key 220, 230. This additional information may vary, as desired, among prompts 210, to increase the accuracy of single field information extraction 214 performed in workflow 200.

For example, in certain embodiments, prompt 210 further includes an indication of a document type associated with document 202. In this example illustrated in FIGS. 2A-2C, prompt 210 may include an indication that document 202 is an IRS Form W-2.

In certain embodiments, prompt 210 further includes an indication of a pattern associated with the requested field key 220, 230 included in prompt 210. The pattern may indicate what an extracted field value 216 for the requested field key 220, 230 looks like. The pattern may indicate a format, a number of digits, a number of characters, a pattern of numbers and/or characters, and/or the like. For example, in this example illustrated in FIGS. 2A-2C, prompt 210 may include additional language reciting “wages, tips, other compensation generally includes a number with a decimal having two digits following the decimal, such as $55.55.” In another example, where the requested field key is a social security field key, prompt 210 may include additional language reciting “a Social Security number generally includes nine digits and is typically formatted as follows: 123-45-6789”.

In certain embodiments, prompt 210 further includes an example of a correct data element extraction, or an example correct field value 216 that may be extracted for the requested field key 220, 230 from example sample text. For instance, prompt 210 may give examples of correct field value extractions from example sample text. For example, prompt 210 may include additional language reciting, “in the following sample text, the Social Security number is ‘123-45-6789’. Sample text: ‘abcd Tax John Smith SSN 123-45-6789 $100 $10000’. Now find the Social Security number in the following OCR text. OCR: ‘ . . . ’.”

Limited field information extraction 214 includes extracting, by the limited field extractor (e.g., LLM), in this example, a field value for the requested field key included in a prompt 210 fed to the limited field extractor. The limited field extractor may use the OCR data 206 when performing such field extraction. In cases where prompt 210 is first example prompt 240 in FIG. 2C, a field value 216 extracted during limited field information extraction 214 may be field value “10846.27” 224 shown in OCR data 206 in FIG. 2B. In cases where prompt 210 is second example prompt 242 in FIG. 2C, a field value 216 extracted during limited field information extraction 214 may be field value “162.23” 232 shown in OCR data 206 in FIG. 2B.

Alternatively, in cases where the prompt used to instruct the limited field extractor indicates to extract field values for a group of field keys, limited field information extraction 214 may include extracting a field value for two or more field keys in the group of field keys. For example, the limited field extractor may extract a first field value, a second field value, and a third field value when prompted to extract information for a group of field keys including a first field key corresponding to the first field value, a second field key corresponding to the second field value, and a third field key corresponding to the third field value.

In certain embodiments, limited field information extraction 214 is performed using geometric information associated with document 202 and included in OCR data 206. For example, OCR data 206 may include, in addition to the text shown in OCR data 206, coordinates for one or more bounding boxes. The bounding box(es) may enclose individual words and/or lines of text in OCR data 206. By utilizing geometrical information in OCR data 206, the distance between different field keys and their respective field values in OCR data 206 may be calculated (e.g., the calculated distance(s) may be in real units, pixels, ratios, etc.). The calculated distance(s) may be used to estimate which field values correspond to which field keys in OCR data 206 generated for document 202, for example, based on their horizontal and/or vertical proximity.

In certain embodiments, only first example prompt 240 (FIG. 2C) is fed to the limited field extractor to prompt the extraction of only a field value for “wages, tips, other compensation” field key 220, during limited field information extraction 214. In certain embodiments, only second example prompt 242 is fed to the limited field extractor to prompt the extraction of only a field value for “Medicare tax withheld” field key 230, during limited field information extraction 214. In certain embodiments, however, both first example prompt 240 and second example prompt 242 are fed to the limited field extractor, at different times (e.g., in any order), to extract both (1) a field value for “wages, tips, other compensation” field key 220 and (2) a field value for “Medicare tax withheld” field key 230, where extraction occurs iteratively, or at different times. For example, after generating a first field value 216 during limited field information extraction 214, based on first example prompt 240 or second example prompt 242, workflow 200 may return to prompt generation 208 to repeat prompt generation 208 and limited field information extraction 214 for the other of the first example prompt 240 or the second example prompt 242.

Processing 218 includes further processing by an application of field value(s) 216, extracted using workflow 200. For example, field value(s) 216 extracted by the limited field extractor may be provided to the application for further processing. In certain embodiments, processing performed by the application using the field value(s) 216 may include generating output comprising the extracted field value(s) 216 from the document 202 for display on a computing device. For example, field value “162.23” 232, shown in FIG. 2B, may be generated for display on a client device (e.g., such as client device 150(1), 150(2) in FIG. 1). This information may be displayed on a client device to inform a user about Medicare tax withheld for employee, Pilar Ackerman.

In certain embodiments, multiple extractors are used to extract a field value for a same field key 220, 230 of document 202. One of the extractors may be a limited field extractor used to perform workflow 200 and extract field value 216. The other extractors may be other limited field extractors and/or all-field extractors configured to extract multiple field values at a time for multiple field keys in document 202. Thus, in some cases, for a same field key 220, 230, multiple field value(s) may be extracted, where each field values is extracted by a different extractor (e.g., including at least the limited field extractor used to perform workflow 200 and extract field value 216). Each field value extracted by the extractors may be scored and compared to scores of other field values. The field value with a score greater than a score associated with all other field values may be selected and provided to the application for further processing. As used herein, the score of a field value may indicate how likely the corresponding field value is to be accurate. In certain embodiments, the score may be generated based on one or more rules. For example, one rule may evaluate an accuracy associated with the extractor, which generated the field value (e.g., evaluate how many times the limited field extractor has correctly predicted a field value 216 for any field key and/or specifically for this requested field key 220, 230). In certain embodiments, the score may be generated by one or more ML models (e.g., confidence model(s)). The ML model(s) may determine a score for a field value based on feature(s) associated with the field value being scored, such as a string length, a fraction of characters that are alphanumeric in the field value, and/or the like. For example, the ML model(s) may determine how likely the field value is to be correct based on how the feature(s) have correlated with correctness in training data and generate a score based on the determined likeliness that the field value is correct.

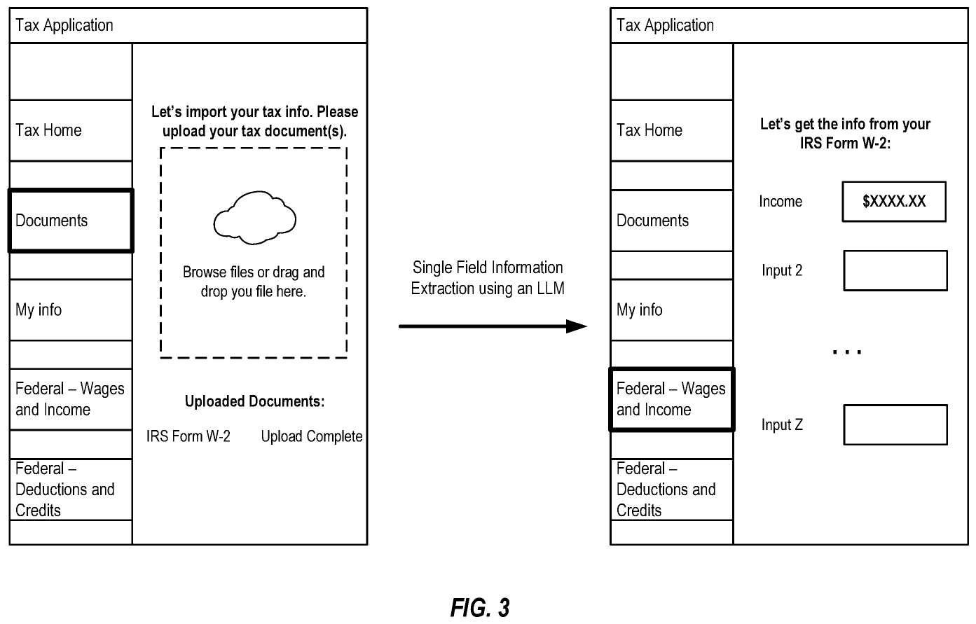

In certain embodiments, processing performed by the application using the field value(s) 216 includes populating a form based on the extracted field value(s) 216 from document 202. For example, population of a form may be performed using mapping rules for mapping the one or more extracted field values 216 from document 202 to one or more data fields included in the form. Example population of a form based on extracted field value(s) for a document 202 is illustrated in FIG. 3.

Specifically, FIG. 3 depicts example use of extracted information by a downstream application, such as a tax application (e.g., TurboTax® and its variants made commercially available by Intuit® of Mountain View, California). As shown, an example document (e.g., a structured document), e.g., IRS Form W-2, may be uploaded to the tax application to create a digitized version of IRS Form W-2 that may be used by the tax application. Using workflow 200 depicted and described with respect to FIG. 2A, OCR data may be generated for IRS Form W-2, a prompt may be created and provided to an LLM to extract a field value for a field key “wages, tips, other compensation” associated with IRS Form W-2 (e.g., using the OCR data), and the field value may be extracted.

The field value extracted by the limited field extractor may be provided to the tax application. The tax application may then use mapping rules to map the extracted field value to an “Income” field in a tax return form provided by the tax application. Similar steps may be performed to extract other field value(s) from IRS Form W-2, e.g., field-by-field, and map these extracted field value(s) to the tax return form provided by the tax application.

In certain embodiments, prior to deploying the limited field extractor (e.g., LLM) for use in performing workflow 200, the limited field extractor may be trained to perform such information extraction. Training the limited field extractor to perform information extraction may include fine tuning the limited field extractor to extract a field value corresponding to a field key using multiple first training prompts comprising at least OCR data from a document type, of one or more document types, and the field key, among one or more field keys. In other words, multiple first training prompts including OCR data for one or more document types and a field key associated with the one or more document types may be used to fine tune the limited field extractor.

In certain embodiments, one or more of the first training prompts may include additional information beyond (1) the OCR data and (2) the field key. For example, the additional information may include a (1) document type associated with a document used to generate the OCR data in a training prompt, (2) a pattern associated with the field key included in a training prompt, and/or (3) an example of a correct data extraction.

In certain embodiments, second training prompts may also be used to train the limited field extractor, where the second training prompts include one or more of the below-described prompts.

In certain embodiments, the second training prompts include prompts requesting the extraction of a subset of fields (e.g., more than one) in a document at a time, where the order of the fields listed in the prompt is selected at random. In particular, a prompt may instruct the limited field extractor to extract field values for multiple field keys in a document. For example, the field keys may correspond to four field keys present in the document. In one second training prompt, a first field key is listed first, a second field key is listed second, a third field key is listed third, and a fourth field key is listed fourth. In other second training prompts, the order of the field keys may be different. For example, the order of the field keys in the second training prompt may be chosen at random.

In certain embodiments, the second training prompts include prompts requesting the extraction of information for fields not present in a document. For example, a second training prompt may include OCR data generated for a document and a field key. The field key may not exist in the document. Thus, this second training prompt may be used to train the extractor to determine when a requested field key is not present in the OCR data included in the prompt.

In certain embodiments, the second training prompts include non-extraction type prompts. For example, the second training prompts may include (1) Boolean questions (e.g., asking the extractor respond with “yes” or “no” to questions about the presence of a key field in a document), (2) permutation questions (e.g., asking the extractor to match an extracted field value from a document to a correct field key in the document), (3) address matching questions (e.g., asking the extractor to identify whether an address included in the second training prompt belongs to a payer, recipient, employer, employee, etc.).

### Example Accuracy Improvement Using a Limited Field Extractor Versus a Comprehensive Field Extractor across Document Types

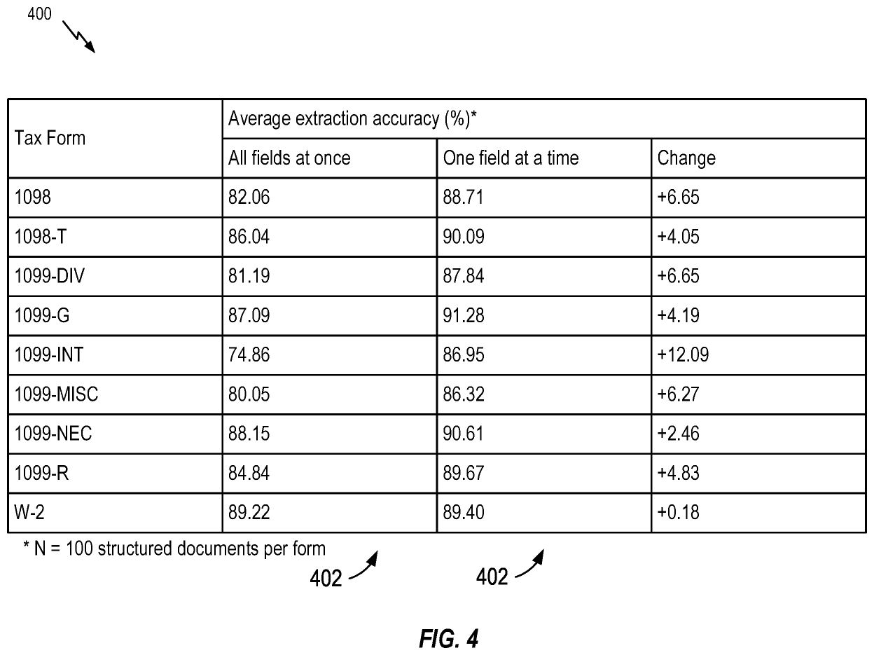

FIG. 4 depicts an example of the improvement in accuracy of an LLM-based limited field extraction model (for example, a single field extraction model) over a comprehensive field extraction model across document types. Specifically, table 400 shows the average extraction accuracy (%) when extracting field values for all field keys of a document at once (e.g., return all field values for all field keys in one call) (e.g., shown in column 402) and the average extraction accuracy (%) when extracting a field value for a single field key at a time, but for all field keys in the same document (e.g., shown in column 404). The average accuracies are computed based on performing extraction on a variety of IRS tax forms. More specifically, the average accuracies are computed based on performing an extraction on 900 documents associated with nine different tax form types.

As shown in table 400, performing single field information extraction had approximately a 5% higher accuracy on average than extracting information for all field keys at once. For example, an average of the percentages included in column 402 is equal to 83.7%, an average of the percentages included in column 404 is equal to 89%, and a difference between the two averages is 5.3%. Further, although not shown in FIG. 4, a total inference time for performing the single field extraction was only modestly increased for the single field extraction. This modest increase in inferencing time is generally a welcome tradeoff for the improved accuracy.

This increased accuracy beneficially enables users and/or businesses to rely on the extracted information for critical processes, such as financial analysis, inventory management, and/or decision-making. Further, the improved accuracy may also lead to better compliance with regulatory requirements (e.g., such as provided by the United States Tax Code), thereby helping to reduce the risk of penalties and/or legal issues, among other consequences.

### Example Method for Extracting Information

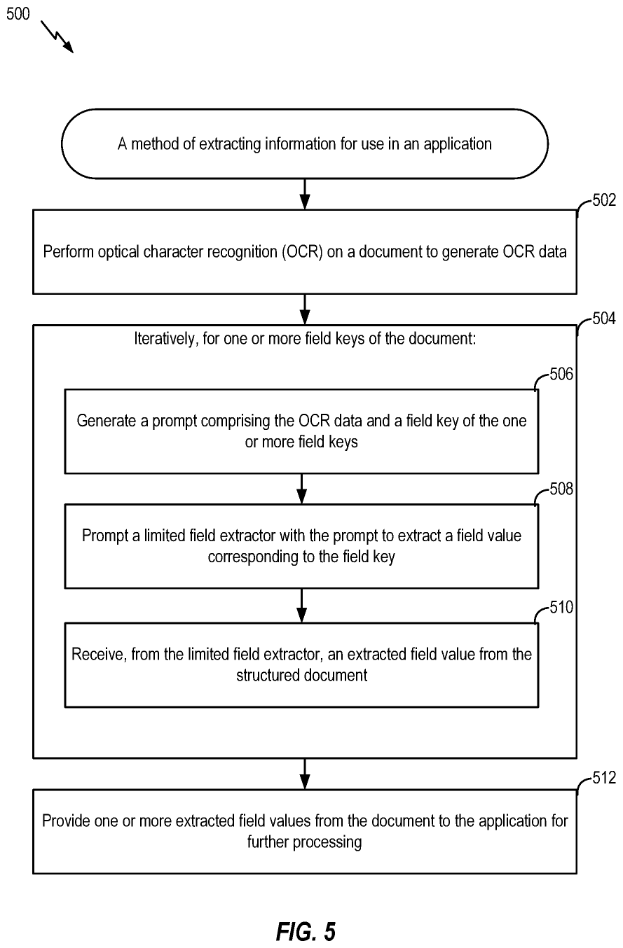

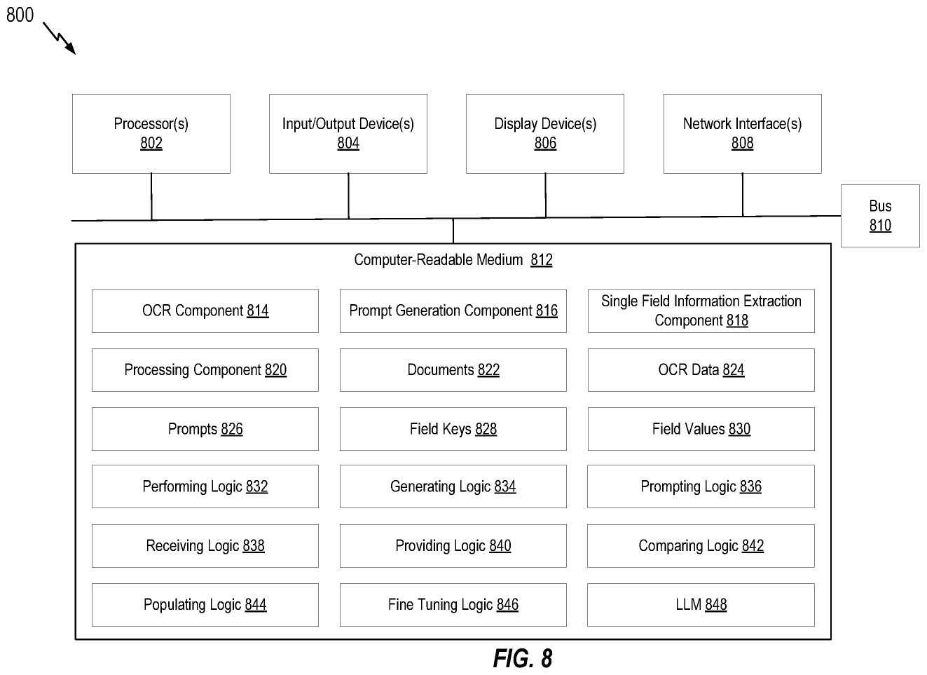

FIG. 5 depicts an example method 500 for extracting information for use in an application. Method 500 may be performed by one or more processor(s) of a computing device, such as processor(s) 802 of processing system 800 described below with respect to FIG. 8.

Method 500 optionally begins, at block 502, with performing OCR on a document to generate OCR data. For example, in certain embodiments, OCR data used in method 500 is received by a limited extractor service rather than generated in method 500.

Method 500 proceeds, at block 504, with iteratively, for one or more field keys of the document, performing steps at blocks 506-510.

At block 506, method 500 proceeds with generating a prompt comprising the OCR data and a field key of the one or more field keys.

At block 508, method 500 proceeds with prompting a limited field extractor with the prompt to extract a field value corresponding to the field key.

At block 510, method 500 proceeds with receiving, from the limited field extractor, an extracted field value from the document.

Method 500 then proceeds, at block 512, with providing one or more extracted field values from the document to the application for further processing.

In certain embodiments, the limited field extractor is an LLM.

In certain embodiments, the limited field extractor has been fine-tuned to extract a single field value for a single field key from the document at a time.

In certain embodiments, the prompt further comprises a document type associated with the document.

In certain embodiments, the prompt further comprises a pattern associated with the field key of the one or more field keys.

In certain embodiments, the prompt further comprises an example of a correct data element extraction.

In certain embodiments, the OCR data comprises geometric information associated with the document.

In certain embodiments, method 500 further includes generating a score for at least one extracted field value of the one or more extracted field values and comparing the score for the at least one extracted field value and scores associated with other extracted field values for the same field key associated with the at least one extracted field value, where the other extracted field values may be extracted by one or more other extractors. Method 500 may further include selecting the at least one extracted field value or one of the other extracted field values based on comparing the score for the at least one extracted field value and the scores associated with other extracted field values. Thus, providing, at block 512, the one or more extracted field values to the application for further processing may include providing the at least one extracted field value or the one of the other extracted field values based on the selecting the at least one extracted field value or the one of the other extracted field values.

In certain embodiments, the one or more field keys of the document comprise at least one of: a taxpayer legal name field key; a taxpayer legal address field key; a taxpayer identification field key; a wages, tips, and other compensation field key associated with an Internal Revenue Service (IRS) Form W-2; a federal income tax withheld field key associated with the IRS Form W-2; a total ordinary dividends field key associated with an IRS Form 1099-DIV; a qualified dividends field key associated with the IRS Form 1099-DIV; a total capital gain distribution field key associated with the IRS Form 1099-DIV; a payments received for qualified tuition and related expenses field key associated with an IRS 1098-T field; or a scholarships or grants field key associated with the IRS 1098-T field.

In certain embodiments, the one or more field keys of the document comprise a composite field key, and the extracted field value from the document corresponding to the composite field key comprises two or more values in one or more rows of the document. An example composite field key may include a field associated with IRS Form W-2 box 12, 15, 16, 17, 18, 19, and/or 20. Another example composite field key may include a field associated with IRS Form 1099-R box 14, 15, 16, 17, 18, and/or 19.

In certain embodiments, further processing performed by the application comprises at least one of: generating output comprising the one or more extracted field values from the document for display on a computing device or populating a form based on the one or more extracted field values from the document using mapping rules for mapping the one or more extracted field values from the document to one or more data fields included in the form.

Note that FIG. 5 is just one example of a method, and other methods including fewer, additional, or alternative steps are possible consistent with this disclosure.

### Another Example Method for Extracting Information

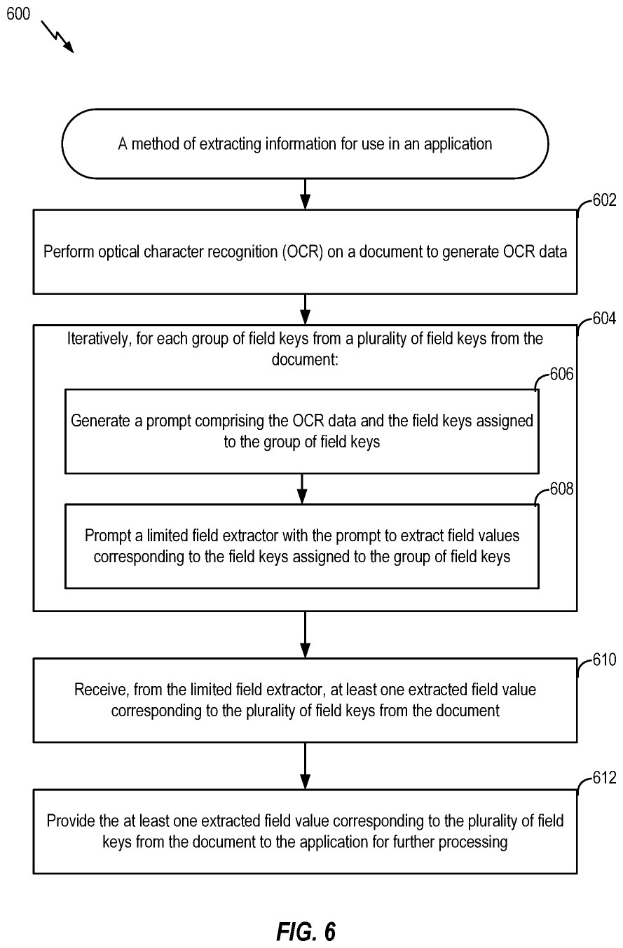

FIG. 6 depicts another example method 600 for extracting information. Method 600 may be performed by one or more processor(s) of a computing device, such as processor(s) 802 of processing system 800 described below with respect to FIG. 8.

Method 600 optionally begins, at block 602, with performing OCR on a document to generate OCR data. For example, OCR data may or may not be generated in method 600. The document may include a plurality of field keys, and one or more field keys of the plurality of field keys are assigned to one or more groups of field keys.

Method 600 proceeds, at block 604, with iteratively, for each group of field keys from a plurality of field keys from the document, performing steps at blocks 606 and 608.

At block 606, method 600 proceeds with generating a prompt comprising the OCR data and the field keys assigned to the group of field keys.

At block 608, method 600 proceeds with prompting a limited field extractor with the prompt to extract field values corresponding to the field keys assigned to the group of field keys.

At block 610, method 600 proceeds with receiving, from the limited field extractor, at least one extracted field value corresponding to the plurality of field keys from the document.

Method 600 then proceeds, at block 612, with providing the at least one extracted field value corresponding to the plurality of field keys from the document to the application for further processing.

In certain embodiments, a group of field keys includes a number of field keys less than a maximum field key threshold, greater than a minimum field key threshold, or equal to a pre-determined number of field keys.

In certain embodiments, a group a group of field keys includes a percentage of a total number of field keys (e.g., 10%, 20%, etc.) included in the document less than a maximum field key percentage threshold, greater than a minimum field key percentage threshold, or equal to a pre-determined percentage of field keys.

In certain embodiments, 1, 2, . . . N groups of field keys exist, where N is an integer greater than zero.

In certain embodiments, one or more of the groups of field keys have a same number of field keys assigned to them. In certain embodiments, all of the groups of field keys have a same number of field keys assigned to them. In certain embodiments, at least one group of field keys has more field keys assigned to the group than another group of field keys. For example, more important field keys may be assigned to smaller groups of field keys (e.g., including less field keys assigned), while less important field keys may be assigned to larger groups of field keys.

In certain embodiments, at least one group of field keys is assigned only one field key.

In certain embodiments, the groups of field keys are disjoint (e.g., no field keys in common among the groups of field keys).

In certain embodiments, the groups of field keys are exhaustive, for example, together including all field keys from the document.

In certain embodiments, the field keys of the document are assigned to the groups of field keys based on semantic similarities or differences between the field keys.

In certain embodiments, the field keys of the document are randomly assigned to the groups of field keys.

Note that FIG. 6 is just one example of a method, and other methods including fewer, additional, or alternative steps are possible consistent with this disclosure.

### Example Method for Training a Limited Field Extractor to Perform Automated Information Extraction

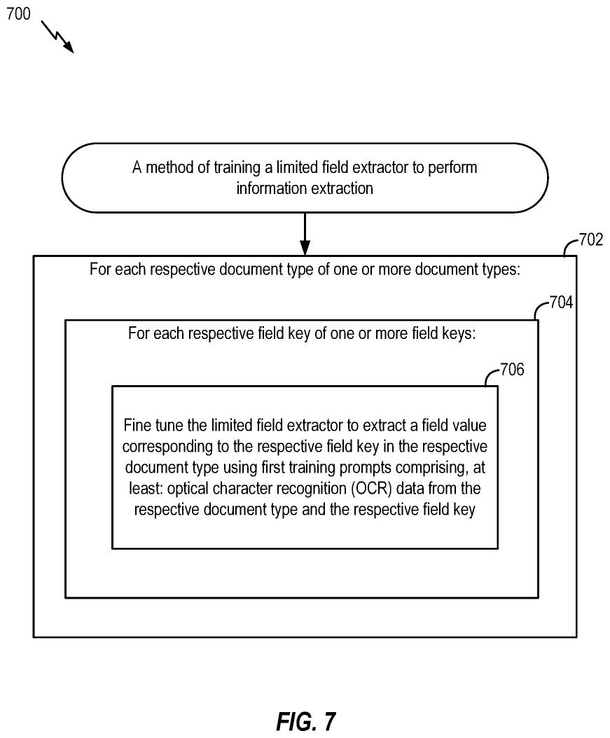

FIG. 7 depicts an example method 700 for training a limited field extractor to perform automated information extraction. Method 700 may be performed by one or more processor(s) of a computing device, such as processor(s) 1002 of processing system 1000 described below with respect FIG. 10.

Method 700 begins, at block 702, with performing steps at blocks 704-706 for each respective document type of one or more document types.

At block 704, method 700 proceeds with performing the step at block 706 for each respective field key of one or more field keys

At block 706, method 700 proceeds with fine tuning the limited field extractor to extract a field value corresponding to the respective field key in the respective document type using first training prompts comprising, at least: OCR data from the respective document type and the respective field key.

In certain embodiments, the limited field extractor is an LLM.

In certain embodiments, at least one of the first training prompts further comprises an indication of the respective document type.

In certain embodiments, at least one of the first training prompts further comprises a pattern associated with the respective field key of the one or more field keys.

In certain embodiments, at least one of the first training prompts further comprises an example of a correct data element extraction.

In certain embodiments, the OCR data from the respective document type comprises geometric information.

In certain embodiments, the one or more field keys comprise a plurality of randomly selected field keys from the one or more document types.

In certain embodiments, method 700 further includes, for at least one respective document type of the one or more document types, fine tuning the limited field extractor to identify one or more second field keys that do not exist in the OCR data from the respective document type but for which the limited field extractor is prompted to extract a field value using second training prompts.

In certain embodiments, method 700 further includes, for at least one respective document type of the one or more document types: for each respective Boolean question of one or more Boolean questions about the respective structure document type: fine tuning the limited field extractor to generate a response to the respective Boolean question.

In certain embodiments, method 700 further includes, for at least one respective document type of the one or more document types: for at least one respective field value of one or more field values corresponding to the one or more field keys: fine tuning the limited field extractor to identify the field key in the respective document type corresponding to the respective field value using second training prompts comprising, at least: the OCR data from the respective document type; and the respective field value.

In certain embodiments, the one or more field values comprise one or more addresses.

Note that FIG. 7 is just one example of a method, and other methods including fewer, additional, or alternative steps are possible consistent with this disclosure.

### Example Processing System for Extracting Information

FIG. 8 depicts an example processing system 800 configured to perform various aspects described herein, including, for example, method 600 as described above with respect to FIG. 6 and/or method 700 as described above with respect to FIG. 7.

Processing system 800 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 800 includes one or more processors 802, one or more input/output devices 804, one or more display devices 806, one or more network interfaces 808 through which processing system 800 is connected to one or more networks (e.g., a local network, an intranet, the Internet, or any other group of processing systems communicatively connected to each other), and computer-readable medium 812. In the depicted example, the aforementioned components are coupled by a bus 810, which may generally be configured for data exchange amongst the components. Bus 810 may be representative of multiple buses, while only one is depicted for simplicity.

Processor(s) 802 are generally configured to retrieve and execute instructions stored in one or more memories, including local memories like computer-readable medium 812, as well as remote memories and data stores. Similarly, processor(s) 802 are configured to store application data residing in local memories like the computer-readable medium 812, as well as remote memories and data stores. More generally, bus 810 is configured to transmit programming instructions and application data among the processor(s) 802, input/output device(s) 804, display device(s) 806, network interface(s) 808, and/or computer-readable medium 812. In certain embodiments, processor(s) 802 are representative of one or more central processing units (CPUs), graphics processing unit (GPUs), tensor processing unit (TPUs), accelerators, and other processing devices.

Input/output device(s) 804 may include any device, mechanism, system, interactive display, and/or various other hardware and software components for communicating information between processing system 800 and a user of processing system 800. For example, input/output device(s) 804 may include input hardware, such as a keyboard, touch screen, button, microphone, speaker, and/or other device for receiving inputs from the user and sending outputs to the user.

Display device(s) 806 may generally include any sort of device configured to display data, information, graphics, user interface elements, and the like to a user. For example, display device(s) 806 may include internal and external displays such as an internal display of a tablet computer or an external display for a server computer or a projector. Display device(s) 806 may further include displays for devices, such as augmented, virtual, and/or extended reality devices. In various embodiments, display device(s) 806 may be configured to display a graphical user interface.

Network interface(s) 808 provide processing system 800 with access to external networks and thereby to external processing systems. Network interface(s) 808 can generally be any hardware and/or software capable of transmitting and/or receiving data via a wired or wireless network connection. Accordingly, network interface(s) 808 can include a communication transceiver for sending and/or receiving any wired and/or wireless communication.

Computer-readable medium 812 may be a volatile memory, such as a random access memory (RAM), or a nonvolatile memory, such as nonvolatile random access memory (NVRAM), or the like. In this example, computer-readable medium 812 includes an OCR component 814, a prompt generation component 816, a single field information extraction component 818, a processing component 820, documents 822, OCR data 824, prompts 826, field keys 828, field values 830, performing logic 832, generating logic 834, prompting logic 836, receiving logic 838, providing logic 840, comparing logic 842, populating logic 844, fine tuning logic 846, and an LLM 848.

In certain embodiments, component performing logic 832 includes logic for performing OCR on a document to generate OCR data for use in an application.

In certain embodiments, generating logic 834 includes logic for generating a prompt comprising the OCR data and a field key of the one or more field keys. In certain embodiments, generating logic 834 includes logic for generating a score for at least one extracted field value of the one or more extracted field values. In certain embodiments, generating logic 834 includes logic for generating output comprising the one or more extracted field values from the document for display on a computing device.

In certain embodiments, prompting logic 836 includes logic for prompting a LLM with the prompt to extract a field value corresponding to the field key.

In certain embodiments, receiving logic 838 includes logic for receiving, from the LLM, an extracted field value from the document.

In certain embodiments, providing logic 840 includes logic for providing one or more extracted field values from the document to the application for further processing. In certain embodiments, providing logic 840 includes logic for providing at least one extracted field value, extracted by a limited field extractor, or one extracted field value among other extracted field values, extracted by one or more other extractors, to the application for further processing.

In certain embodiments, comparing logic 842 includes logic for comparing the score for the at least one extracted field value to scores associated with other extracted field values for the same field key associated with the at least one extracted field value, wherein: the other extracted field values are extracted by one or more other extractors.

In certain embodiments, populating logic 844 includes logic for populating a form based on the one or more extracted field values from the document using mapping rules for mapping the one or more extracted field values from the document to one or more data fields included in the form.

In certain embodiments, fine tuning logic 846 includes logic for fine tuning the LLM to extract a field value corresponding to the respective field key in the respective document type using first training prompts comprising, at least: OCR data from the respective document type; and the respective field key. In certain embodiments, fine tuning logic 846 includes logic for fine tuning the LLM to generate a response to the respective Boolean question. In certain embodiments, fine tuning logic 846 includes logic for, for at least one respective field value of one or more field values corresponding to the one or more field keys, fine tuning the LLM to identify the field key in the respective document type corresponding to the respective field value using second training prompts comprising, at least: the OCR data from the respective document type; and the respective field value.

Note that FIG. 8 is just one example of a processing system consistent with aspects described herein, and other processing systems having additional, alternative, or fewer components are possible consistent with this disclosure.

### EXAMPLE CLAUSES

Implementation examples are described in the following numbered clauses:

Clause 1: A method of extracting information, comprising: performing optical character recognition (OCR) on a document to generate OCR data for use in an application; iteratively, for one or more field keys of the document: generating a prompt comprising the OCR data and a field key of the one or more field keys; prompting a limited field extractor (e.g., a large language model (LLM)) with the prompt to extract a field value corresponding to the field key; and receiving, from the limited field extractor, an extracted field value from the document; and providing one or more extracted field values from the document to the application for further processing.

Clause 2: The method of Clause 1, wherein the limited field extractor has been fine-tuned to extract a single field value for a single field key from the document at a time.

Clause 3: The method of any one of Clauses 1-2, wherein the prompt further comprises a document type associated with the document.

Clause 4: The method of any one of Clauses 1-3, wherein the prompt further comprises a pattern associated with the field key of the one or more field keys.

Clause 5: The method of any one of Clauses 1-4, wherein the prompt further comprises an example of a correct data element extraction.

Clause 6: The method of any one of Clauses 1-5, wherein the OCR data comprises geometric information associated with the document.

Clause 7: The method of any one of Clauses 1-6, further comprising: generating a score for at least one extracted field value of the one or more extracted field values; and comparing the score for the at least one extracted field value and scores associated with other extracted field values for the same field key associated with the at least one extracted field value, wherein: the other extracted field values are extracted by one or more other extractors, selecting the at least one extracted field value or one of the other extracted field values based on comparing the score for the at least one extracted field value and the scores associated with other extracted field values, wherein providing the one or more extracted field values to the application for further processing comprises providing the at least one extracted field value or the one of the other extracted field values based on the selecting the at least one extracted field value or the one of the other extracted field values.

Clause 8: The method of any one of Clauses 1-7, wherein the one or more field keys of the document comprises at least one of: a taxpayer legal name field key; a taxpayer legal address field key; a taxpayer identification field key; a wages, tips, and other compensation field key associated with an Internal Revenue Service (IRS) Form W-2; a federal income tax withheld field key associated with the IRS Form W-2; a total ordinary dividends field key associated with an IRS Form 1099-DIV; a qualified dividends field key associated with the IRS Form 1099-DIV; a total capital gain distribution field key associated with the IRS Form 1099-DIV; a payments received for qualified tuition and related expenses field key associated with an IRS 1098-T field; or a scholarships or grants field key associated with the IRS 1098-T field.

Clause 9: The method of any one of Clauses 1-8, wherein: the one or more field keys of the document comprise a composite field key, and the extracted field value from the document corresponding to the composite field key comprises two or more values in one or more rows of the document.

Clause 10: The method of any one of Clauses 1-9, wherein the further processing performed by the application comprises at least one of: generating output comprising the one or more extracted field values from the document for display on a computing device; or populating a form based on the one or more extracted field values from the document using mapping rules for mapping the one or more extracted field values from the document to one or more data fields included in the form.

Clause 11: A method of training a limited field extractor (e.g., a large language model (LLM)) to perform information extraction, comprising: for each respective document type of one or more document types: for each respective field key of one or more field keys: fine tuning the limited field extractor to extract a field value corresponding to the respective field key in the respective document type using first training prompts comprising, at least: optical character recognition (OCR) data from the respective document type; and the respective field key.

Clause 12: The method of Clause 11, wherein at least one of the first training prompts further comprises an indication of the respective document type.

Clause 13: The method of any one of Clauses 11-12, wherein at least one of the first training prompts further comprises a pattern associated with the respective field key of the one or more field keys.

Clause 14: The method of any one of Clauses 11-13, wherein at least one of the first training prompts further comprises an example of a correct data element extraction.

Clause 15: The method of any one of Clauses 11-14, wherein the OCR data from the respective document type comprises geometric information.

Clause 16: The method of any one of Clauses 11-15, wherein the one or more field keys comprise a plurality of randomly selected field keys from the one or more document types.

Clause 17: The method of any one of Clauses 11-16, further comprising: for at least one respective document type of the one or more document types, fine tuning the limited field extractor to identify one or more second field keys that do not exist in the OCR data from the respective document type but for which the limited field extractor is prompted to extract a field value using second training prompts.

Clause 18: The method of any one of Clauses 11-17, further comprising: for at least one respective document type of the one or more document types: for each respective Boolean question of one or more Boolean questions about the respective document type: fine tuning the limited field extractor to generate a response to the respective Boolean question.

Clause 19: The method of any one of Clauses 11-18, further comprising: for at least one respective document type of the one or more document types: for at least one respective field value of one or more field values corresponding to the one or more field keys: fine tuning the limited field extractor to identify the field key in the respective document type corresponding to the respective field value using second training prompts comprising, at least: the OCR data from the respective document type; and the respective field value.

Clause 20: The method of Clause 19, wherein the one or more field values comprise one or more addresses.

Clause 21: A processing system, comprising: one or more memories comprising computer-executable instructions; and one or more processors configured to execute the computer-executable instructions and cause the processing system to perform a method in accordance with any one of Clauses 1-20.

Clause 22: A processing system, comprising means for performing a method in accordance with any one of Clauses 1-20.

Clause 23: A non-transitory computer-readable medium storing program code for causing a processing system to perform the steps of any one of Clauses 1-20.

Clause 24: A computer program product embodied on a computer-readable storage medium comprising code for performing a method in accordance with any one of Clauses 1-20.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of extracting information for use in an application, comprising:
performing optical character recognition (OCR) on a document to generate OCR data;
iteratively, for one or more field keys of the document:
generating a prompt comprising the OCR data and a field key of the one or more field keys;
prompting a limited field extractor with the prompt to extract a field value corresponding to the field key; and
receiving, from the limited field extractor, an extracted field value from the document; and
providing one or more extracted field values from the document to the application for further processing.

2. The method of claim 1, wherein the limited field extractor has been fine-tuned to extract a single field value for a single field key from the document at a time.

3. The method of claim 1, wherein the prompt further comprises a document type associated with the document.

4. The method of claim 1, wherein the prompt further comprises a pattern associated with the field key of the one or more field keys.

5. The method of claim 1, wherein the prompt further comprises an example of a correct data element extraction.

6. The method of claim 1, wherein the OCR data comprises geometric information associated with the document.

7. The method of claim 1, further comprising:
generating a score for at least one extracted field value of the one or more extracted field values; and
comparing the score for the at least one extracted field value and scores associated with other extracted field values for the same field key associated with the at least one extracted field value, wherein the other extracted field values are extracted by one or more other extractors; and
selecting the at least one extracted field value or one of the other extracted field values based on comparing the score for the at least one extracted field value and the scores associated with other extracted field values,
wherein providing the one or more extracted field values to the application for further processing comprises providing the at least one extracted field value or the one of the other extracted field values based on the selecting the at least one extracted field value or the one of the other extracted field values.

8. The method of claim 1, wherein the one or more field keys of the document comprises at least one of:
a taxpayer legal name field key;
a taxpayer legal address field key;
a taxpayer identification field key;
a wages, tips, and other compensation field key associated with an Internal Revenue Service (IRS) Form W-2;
a federal income tax withheld field key associated with the IRS Form W-2;
a total ordinary dividends field key associated with an IRS Form 1099-DIV;
a qualified dividends field key associated with the IRS Form 1099-DIV;
a total capital gain distribution field key associated with the IRS Form 1099-DIV;
a payments received for qualified tuition and related expenses field key associated with an IRS 1098-T field; or
a scholarships or grants field key associated with the IRS 1098-T field.

9. The method of claim 1, wherein:
the one or more field keys of the document comprise a composite field key, and
the extracted field value from the document corresponding to the composite field key comprises two or more values in one or more rows of the document.

10. The method of claim 1, wherein the further processing performed by the application comprises at least one of:
generating output comprising the one or more extracted field values from the document for display on a computing device; or
populating a form based on the one or more extracted field values from the document using mapping rules for mapping the one or more extracted field values from the document to one or more data fields included in the form.

11. A method of training a limited field extractor to perform information extraction, comprising:
for each respective document type of one or more document types:
for each respective field key of one or more field keys:
fine tuning the limited field extractor to extract a field value corresponding to the respective field key in the respective document type using first training prompts comprising, at least:
optical character recognition (OCR) data from the respective document type; and
the respective field key.

12. The method of claim 11, wherein at least one of the first training prompts further comprises an indication of the respective document type.

13. The method of claim 11, wherein at least one of the first training prompts further comprises a pattern associated with the respective field key of the one or more field keys.

14. The method of claim 11, wherein at least one of the first training prompts further comprises an example of a correct data element extraction.

15. The method of claim 11, wherein the OCR data from the respective document type comprises geometric information.

16. The method of claim 11, wherein the one or more field keys comprise a plurality of randomly selected field keys from the one or more document types.

17. The method of claim 11, further comprising:
for at least one respective document type of the one or more document types, fine tuning the limited field extractor to identify one or more second field keys that do not exist in the OCR data from the respective document type but for which the limited field extractor is prompted to extract a field value using second training prompts.

18. The method of claim 11, further comprising:
for at least one respective document type of the one or more document types:
for each respective Boolean question of one or more Boolean questions about the respective document type:
fine tuning the limited field extractor to generate a response to the respective Boolean question.

19. The method of claim 11, further comprising:
for at least one respective document type of the one or more document types:
for at least one respective field value of one or more field values corresponding to the one or more field keys:
fine tuning the limited field extractor to identify the field key in the respective document type corresponding to the respective field value using second training prompts comprising, at least:
the OCR data from the respective document type; and
the respective field value.

20. A processing system, comprising:
one or more memories comprising computer-executable instructions; and
one or more processors configured to execute the computer-executable instructions and cause the processing system to:
perform optical character recognition (OCR) on a document to generate OCR data for use in an application;
iteratively, for one or more field keys of the document:
generate a prompt comprising the OCR data and a field key of the one or more field keys;
prompt a limited field extractor with the prompt to extract a field value corresponding to the field key; and
receive, from the limited field extractor, an extracted field value from the document; and
provide one or more extracted field values from the document to the application for further processing.
